(19) United States
(12) Patent Application Publication
(10) Pub. No.: US 2018/0345973 A1
(43) Pub. Date: Dec. 6, 2018

(54) VEHICLE HAVING CONTROLLED START

(71) Applicant: GM GLOBAL TECHNOLOGY OPERATIONS LLC, Detroit, MI (US)

(72) Inventors: Eric E. Krueger, Milford, MI (US); Alexander J. MacDonald, Milford, MI (US); Michael G. Petrucci, Milford, MI (US); Anthony J. Rifici, Milford, MI (US); Ryan Z. Goode, Milford, MI (US); Aniket Kothari, Pontiac, MI (US); Jonathan P. Kish, Pontiac, MI (US)

(21) Appl. No.: 15/757,811

(22) PCT Filed: Sep. 9, 2016
(86) PCT No.: PCT/US2016/050943

§ 371 Date: Mar. 6, 2018

Related U.S. Application Data
(60) Provisional application No. 62/217,499, filed on Sep. 11, 2015.
(60) Provisional application No. 62/217,830, filed on Sep. 12, 2015.
(60) Provisional application No. 62/217,915, filed on Sep. 13, 2015.
(60) Provisional application No. 62/217,905, filed on Sep. 13, 2015.

(51) Int. Cl. B60W 30/18; B60T 8/171; B60T 8/175; B60K 23/02; B60W 10/02; B60W 10/184; B60W 10/06; B60K 23/04; B60W 10/12

(52) U.S. Cl. CPC B60W 30/18027; B60W 2720/26; B60T 8/175; B60K 23/02; B60W 10/02; B60W 10/184; B60W 10/06; B60K 23/04; B60W 10/12; B60T 2240/00; B60T 2250/02; B60T 2270/20; B60W 2520/28; B60W 2710/0666; B60W 2710/025; B60W 2710/18; B60W 2510/0657; B60W 2710/12; B60T 8/171

(57) ABSTRACT

A vehicle and method is provided. The vehicle includes systems and method for limiting the slip of the wheels. In an embodiment, the system holds the brakes based on an acceleration characteristic measured by a sensor. In another embodiment, the system includes a transmission controller that applies an adjustment to limit an amount of clutch slip as the clutch temperature to change in clutch performance to reduce wheel slip. In another embodiment, the system monitors wheel slip signal from a sensor and compares the wheel slip to a target slip value and controls clutch slip of the transmission clutch based to maintain engine output torque during acceleration. In another embodiment, in response to an anticipated vehicle launch event, a drive motor applies a first torque to the input shaft to adjust a gear lash of the differential unit.

### CROSS-REFERENCE TO RELATED APPLICATIONS

The present application claims the benefit of U.S. Provisional Application Ser. No. 62/217,830 filed on Sep. 12, 2015. The present application also claims the benefit of U.S. Provisional Application Ser. No. 62/217,499 filed on Sep. 11, 2015. The present application also claims the benefit of U.S. Provisional Application Ser. No. 62/217,905 filed on Sep. 13, 2015. The present application also claims the benefit of U.S. Provisional Application Ser. No. 62/217,915 filed on Sep. 13, 2015. The contents of all of the above referenced United States Provisional Applications are incorporated by reference herein in their entirety.

### FIELD OF THE INVENTION

The subject invention relates to a vehicle, and more particularly, to a system that is configured to improve the starting performance and acceleration of the vehicle.

### BACKGROUND

One measure of performance for a vehicle, such as an automobile or a passenger truck, is the acceleration of the vehicle from a stopped position to a given speed. For example, the time to accelerate from 0 miles per hour (mph) to 60 mph is a common metric used to compare different vehicles and the level of performance that may be expected from a particular vehicle. It should be appreciated that there are a number of factors that contribute to this time metric.

One area that increases the acceleration time is the period between when the operator depresses the accelerator pedal to the initial movement of the vehicle (i.e. vehicle launched). A number of things occur during this period. First, the operator must move his/her foot from the brake pedal to the accelerator. Then the accelerator pedal needs to be depressed, which transmits a signal (mechanically or electrically) from the accelerator pedal to the engine control module. The engine then accelerates from an idle speed to a higher number of revolutions per minute. The engine torque is next transferred to the wheels via a transmission. It should be appreciated that all of these things have to occur prior to the vehicle moving. Further, as the engine speed increases, the vehicle will start to move, but the maximum desired torque may not have yet been achieved. As a result, the rate of acceleration of the vehicle will start slowly and then increase as the full torque from the engine is delivered to the wheels.

Further, in some instances the too much torque may be applied to the wheels, resulting in a slippage of the wheels relative to the ground. As a result, the acceleration of the vehicle may be slowed. Still further factors may include the clearance between internal components within the vehicle, such as the amount of lash between gears. It should be appreciated that the more clearance (e.g. greater lash) may also delay acceleration of the vehicle while the clearances are closed as the torque from the engine is transferred to the wheels.

Accordingly, while existing vehicles are suitable for their intended purposes the need for improvement remains, particularly in providing a vehicle with an improved acceleration.

### SUMMARY OF THE INVENTION

In one exemplary embodiment of the invention, a vehicle is provided. The vehicle comprises a braking system having a rotor and a caliper. A propulsion system is provided. At least one sensor is coupled to the vehicle to determine an acceleration characteristic. A controller is electrically coupled to the engine, the braking system and the at least one sensor. The controller is responsive to executable computer instructions when executed on a processor for transmitting a brake-holding signal to the braking system in response to receiving an acceleration signal from the at least one sensor and transmitting a release signal to the braking system to release a clamping force by the caliper in response to the propulsion system outputting a predetermined torque.

In another exemplary embodiment of the invention, a method of operating a vehicle is provided. The method comprises: releasing a brake pedal and depressing an accelerator pedal; applying a clamping force to a brake rotor with a caliper when the accelerator pedal is depressed; increasing the torque output of a propulsion system in response to depressing the accelerator pedal; and decreasing the clamping force from the brake rotor when the torque output increases to a predetermined torque.

In another exemplary embodiment of the invention, a vehicle is provided. The vehicle includes a braking system having a brake pedal, a rotor and a caliper. A propulsion system is provided. An accelerator pedal is operably coupled to the propulsion system. At least one sensor is coupled to the vehicle to determine an acceleration characteristic. A computer program product is provided comprising a computer readable storage medium having program instructions embodied therewith, the program instructions executable by a processor to cause the processor to perform: determining the brake pedal has been released and the accelerator pedal depressed; applying a clamping force to a brake rotor with a caliper when the accelerator pedal is depressed; increasing the torque output of the propulsion system in response to depressing the accelerator pedal; and decreasing the clamping force from the brake rotor when the torque output increases to a predetermined torque.

In another exemplary embodiment of the invention, another vehicle is provided. The vehicle includes at least one transmission clutch and a drive wheel operably connected to the at least one transmission clutch. A transmission controller is operably disposed and configured to apply an adjustment to limit an amount of clutch slip as the clutch temperature increases due to repeated launches of the vehicle, resulting in a change in clutch performance. A controller is provided having a processing circuit responsive to executable instructions which when executed by the processing circuit facilitates a change in a slip of the drive wheel as a result of the change in clutch performance due to the applied adjustment.

In another exemplary embodiment of the invention, a method of determining a Desired Wheel Slip of a vehicle having at least one transmission clutch, a drive wheel operably connected to the at least one transmission clutch, a transmission controller operably disposed and configured to apply an adjustment to limit an amount of clutch slip as the clutch temperature increases due to repeated launches of the vehicle, resulting in a change in clutch performance, and a vehicle controller having a processing circuit responsive to executable instructions which when executed by the processing circuit facilitates a change in a slip of the drive wheel as a result of the change in clutch performance due to the applied adjustment, the method includes: receiving a Transmission Ratio specific to the vehicle; receiving a Final Drive Ratio specific to the vehicle; determining a Transmission Controller Desired Engine Speed; determining a Brake Controller Desired Engine Speed; and determining the Desired Wheel Slip according to the following: Desired Wheel Slip=(Brake Controller Desired Engine Speed−Transmission Controller Desired Engine Speed)/(Transmission Ratio*Final Drive Ratio).

In another embodiment of the invention, another vehicle is provided. The vehicle including a transmission clutch and a driven wheel operably connected to the transmission clutch. A sensor is configured to monitor wheel slip of the driven wheel. A computer-based controller is configured to receive a monitored wheel slip signal from the sensor indicative of the monitored wheel slip and compare the monitored wheel slip to a target wheel slip value, and wherein the computer-based controller is configured to control clutch slip of the transmission clutch based on the monitored wheel slip to substantially maintain engine output torque during acceleration.

In another exemplary embodiment, a method of accelerating a vehicle includes producing a desired engine output torque and sensing wheel slip relative to a surface upon which the vehicle travels. The sensed wheel slip is then compared to a target wheel slip value by a computer-based controller. When the target wheel slip value is reached, the clutch slip is increased.

In another embodiment of the invention, another vehicle is provided. The vehicle including a differential unit that controls rotation of a first output shaft with respect to a second output shaft. A drive motor is operatively connected to an input shaft that is operatively connected to the differential unit. A controller is programmed to, in response to an anticipated vehicle launch event, command the drive motor to apply a first torque to the input shaft to adjust a gear lash of the differential unit.

According to another embodiment of the present disclosure, an electric all-wheel-drive vehicle is provided. The electric all-wheel drive vehicle includes a controller. The controller is programmed to, in response to an anticipated vehicle launch event, provide a first torque command to a drive motor to adjust a gear lash between an input shaft that is operatively connected to the drive motor and a drive gear of a differential unit that is engaged with the input shaft.

According to yet another embodiment of the present disclosure, a controller for a vehicle is provided. The controller includes input communication channels, output communication channels, and control logic. The input communication channels are configured to receive a brake pedal position and a vehicle speed. The output communication channels are configured to provide commands to a drive motor. The control logic is configured to generate a drive motor command to rotate a pinion gear that is in meshed engagement with a drive gear, in response to a change in brake pedal position becoming less than a threshold brake pedal position and the vehicle speed indicative of the vehicle at a stop. The pinion gear is rotated relative to the drive gear without imparting motion to the drive gear.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of a vehicle having an electronic braking system in accordance with an embodiment;

FIG. 2 is a schematic illustration of a vehicle having an electronic braking system in accordance with another embodiment;

FIG. 3 is a block diagram of an acceleration control system in accordance with an embodiment of the invention;

FIG. 4 is a schematic illustration of a vehicle in accordance with an embodiment;

FIG. 5 is a block diagram of a method of operating the vehicle of FIG. 4 in accordance with an embodiment;

FIG. 6 is a schematic illustration of a vehicle in accordance with an embodiment;

FIG. 7 is a block diagram of vehicle of FIG. 6 in accordance with an embodiment;

FIG. 8 is a block diagram of a method of operating the vehicle of FIG. 6 in accordance with an embodiment;

FIG. 9 is another block diagram of vehicle of FIG. 6 in accordance with another embodiment;

FIG. 10 is a schematic illustration of a vehicle in accordance with an embodiment; and

FIG. 11 is a schematic illustration of a vehicle in accordance with an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

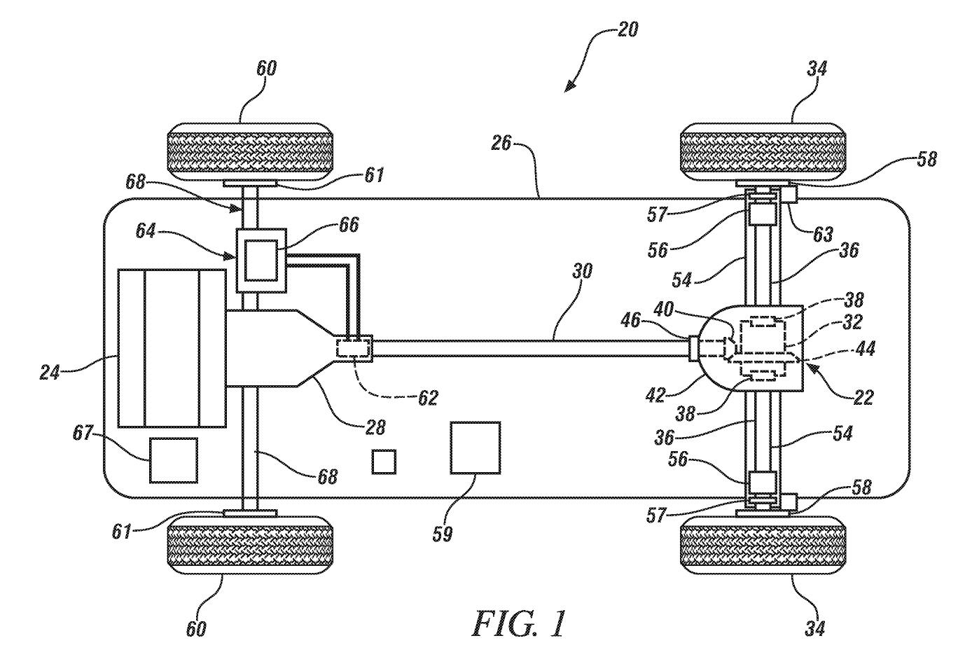

In accordance with an embodiment of the invention, FIG. 1 illustrates a vehicle 20 having a differential assembly 22. The differential assembly 22 may sometimes be referred to as a rear drive module. It should be appreciated that the vehicle 20 may be an automobile, truck, van or sport utility vehicle for example. As used herein, the term vehicle is not limited to just an automobile, truck, van or sport utility vehicle, but may also include any self-propelled or towed conveyance suitable for transporting a burden. The vehicle 20 may include a propulsion system, such as a gasoline or diesel fueled internal combustion engine 24 for example. The engine 24 may further be a hybrid type engine that combines an internal combustion engine with an electric motor for example. The engine 24 and differential assembly 22 are coupled to a frame or other chassis structure 26. The engine 24 is coupled to the rear differential assembly 22 by a transmission 28 and a driveshaft 30. The transmission 28 may be configured to reduce the rotational velocity and increase the torque of the engine output. This modified output is then transmitted to the differential assembly 22 via the driveshaft 30. The rear differential assembly 22 transmits the output torque from the driveshaft 30 through a differential gear set 32 to a pair of driven-wheels 34 via axles 36.

The differential gear set 32 is arranged within a differential housing 42. The differential gear set 32 receives the output from the driveshaft 30 via a pinion 40 that transmits the torque to a ring gear 44. The pinion 40 includes a shaft that is coupled to the driveshaft 30 by a flange 46. The differential gear set 32 is supported for rotation within the housing 42 by a pair of differential bearings. The differential gear set 32 includes side gears 38 arranged within the housing 42 that are coupled to and support one end of the axles 36. The coupling of rotational components, such as the flange 46 to the pinion 40 or the side gears 38 to the axles 36 for example, may be accomplished using a spline connection.

In one embodiment, each axle 36 extends into an axle tube 54. The axle tube 54 includes a hollow interior that extends the length thereof. At one end of the axle tube 54 a bearing 56 is mounted to support the end of the axle 36 adjacent the driven-wheel 34. A shaft seal 57 is located between the bearing 56 and the driven-wheel 34. A brake assembly 58 is coupled to the end of the axle 36 adjacent the bearing 56. The brake assembly 58 is configured to selectively slow the rotation of the wheel 34 in response to an action by the operator, such as applying the brake pedal or activating the parking brake. The brake assembly 58 may be any known braking system used with vehicles, such as a caliper/rotor assembly. In the exemplary embodiment, the brake assembly 58 is connected to a hydraulic circuit that is driven by a hydraulic system 59. The hydraulic system 59 may include a booster device that increases the amount of hydraulic force that is applied to the brakes 58 in response to a deceleration action by the operator. The hydraulic system 59 may be driven by the engine 24 or electrically driven by a separate electrical motor (not shown).

The vehicle 20 further includes a second set of wheels 60 arranged adjacent the engine 24. In one embodiment, the second set of wheels 60 is also configured to receive output from the engine 24. This is sometimes referred to as a four-wheel or an all-wheel drive configuration. In this embodiment, the vehicle 20 may include a transfer case 62 that divides the output from the transmission 28 between the front and rear driven wheels 34, 60. The transfer case 62 transmits a portion of the output to a front differential assembly 64, which may include additional components such as a differential gear set 66 and axles 68 that transmit the output to the wheels 60. Similar to the rear wheels 34, the front wheels 60 include brakes 61. The brakes 61 are configured to selectively slow the rotation of the front wheels 60 in response to a deceleration action by the operator. In the exemplary embodiment, the brakes 61 are also coupled to and actuated by the hydraulic system 59.

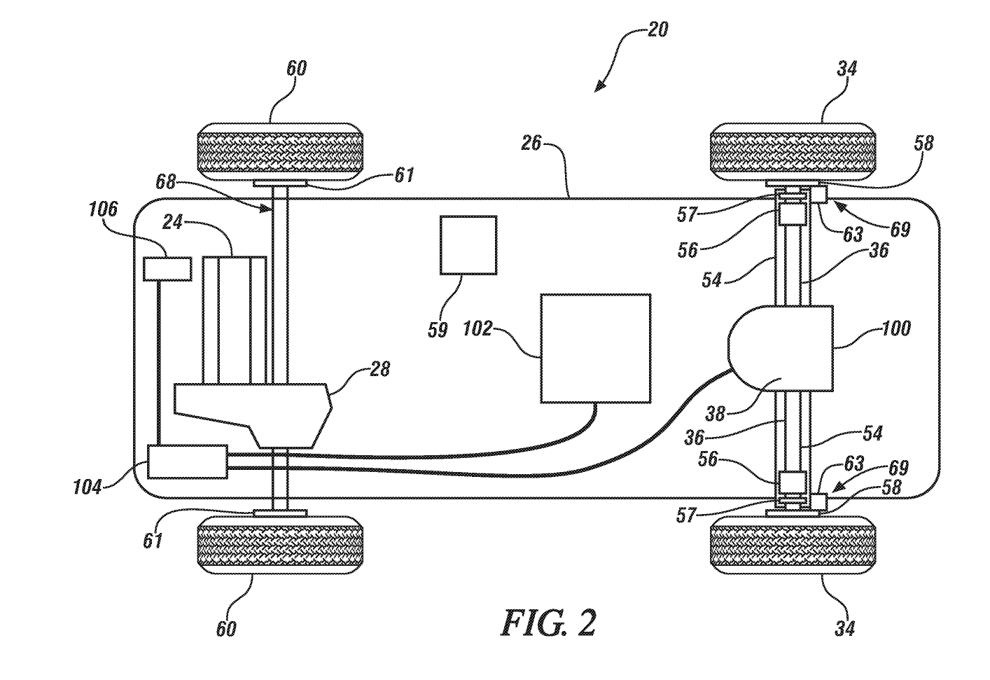

Referring now to FIG. 2, another type of vehicle 20 is shown. In this embodiment, the vehicle 20 includes a rear drive system 100 that uses electrical power from a battery system 102 to provide electrical power to the rear wheels 34. The rear drive system 100 includes one or more electrical motors that are coupled to the rear axles 36 to transfer torque to the rear wheels 34. The battery system 102 is connected to the rear drive system 100 via a power controller 104. A charging system 106 (e.g. a belt driven alternator or generator) may be connected between the engine 24 and the power controller 104 to provide electrical power for replenishing the battery system 102. In an embodiment, the vehicle 20 may further include a regenerative braking system that generates electrical energy in response to the deceleration of the vehicle 20. The regenerative braking system may be configured to further charge the battery system 102. In other embodiments, the vehicle may also be an all-electric vehicle (e.g. electric motors provide torque to both the front and rear wheels). Further, it should be appreciated that while embodiments herein describe the vehicle 20 as being an all-wheel drive or a four-wheel drive vehicle, this is for exemplary purposes and claimed invention should not be so limited. In other embodiments, the propulsion system (e.g. the engine 24 or an electric motor) may provide torque to only one set of wheels, such as only to the front wheels 60 (e.g. a front wheel drive vehicle) or only to the rear wheels 34 (e.g. a rear wheel drive vehicle) for example.

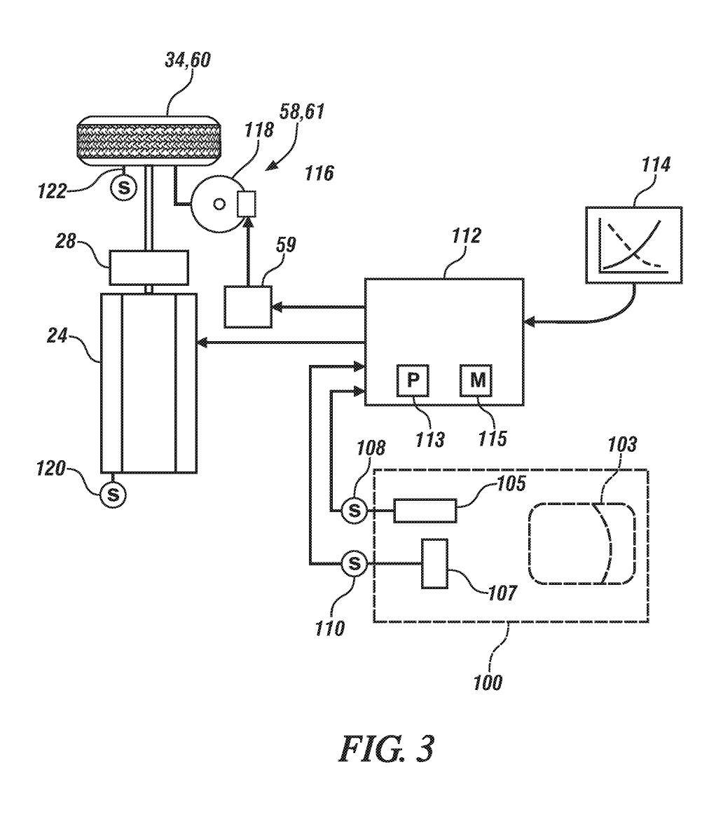

Referring now to FIG. 3, an embodiment is shown of a system for improving the acceleration performance of the vehicle 20. The vehicle 20 includes a passenger compartment 100 that is configured to house (e.g. in seat 103) the operator during operation. The passenger compartment 100 further includes an accelerator pedal 105 and a brake pedal 107. Each of the pedals 105, 107 includes one or more sensors 108, 110 that are configured to measure a parameter associated with the respective pedal 105, 107. For example, the brake pedal 107 may include one or more sensors 110 that measure parameters such as pedal travel and pedal force for example. The accelerator pedal 105 may have one or more sensors 108 that measure accelerator parameters such as pedal travel for example.

The sensors 108, 110 provide input signals to an electronic brake control module (EBCM) 112. The EBCM 112 is an electronic control unit that controls the operation of the brakes 58, 61. The EBCM 112 receives inputs, such as signals from sensors 108, 110, and provides output signals. The EBCM 112 may cooperate with or be integrated with an engine control module (ECM) to control components within the vehicle and change the operating characteristics of the vehicle and achieve a desired result (e.g. increase speed, or slow the vehicle). In addition to the pedal sensors 108, 110, the EBCM 112 may include inputs from many other sensors in the vehicle 20, such as but not limited to engine speed sensors 120, wheel speed sensors 122, fuel and air sensors, exhaust and emissions sensors (not shown) and the like. For example, the EBCM 112 may transmit output signals to the engine 24. These output signals may result in an increased or decreased flow of fuel and air to the engine 24. The output signals may also be transmitted to the hydraulic system 59 to change the amount of clamping pressure applied by the caliper 116 to a brake rotor 118 of brakes 58, 61.

The EBCM 112 may a controller that includes a processor 113 and memory 115. The controller is responsive to executable computer instructions when executed on the processor 113 for performing at least some of the methods disclosed herein. The memory may be used to store data 114, such as look up tables for example, that allow the EBCM 112 to correlate a particular input (e.g. accelerator travel, wheel speed) to determine an output that changes the operating characteristic of the vehicle. In one embodiment, the data 114 may include information that correlates engine torque, brake clamping pressure and tire data to determine the maximum torque that can be delivered to the wheels 34, 60 without causing (or minimizing) the wheels to slip or spin relative to the ground. It should be appreciated that reducing the amount of wheel slip will allow improvements to the acceleration of the vehicle.

In an embodiment, the amount of time for acceleration to a desired speed (e.g. 0-60 mph) may be improved by controlling the engine 24 and the brakes 58, 61 to prevent movement of the wheels 34, 60 and thus the vehicle 20 until a predetermined engine output torque has been achieved. In operation, the vehicle 20 starts at a stationary position, with EBCM 112 maintaining the brakes 58, 61 with sufficient clamping force on the rotors 118 to maintain the vehicle at rest. When the operator moves his/her foot from the brake pedal 107 to the accelerator pedal 105, the EBCM 112 maintains the clamping force applied to the rotors 118 to prevent movement of the wheels 34, 60 and vehicle 20.

As the operator depresses the accelerator pedal 105, the EBCM 112 receives input signals from the accelerator pedal 105 and outputs signals to the engine 24 and hydraulic system 59. The signal to engine 24 causes an increase in the engine speed (RPM) while the signal to the hydraulic system 59 maintains or increases the clamping force by the caliper 116 on the rotor 118 to keep the vehicle 20 stationary by the brake operation. As the engine 24 speed increases to a desired operating level, the engine torque is transmitted to the wheels 34, 60 (via transmission 28). Due to the clamping force on the rotors 118 by the caliper 116 the vehicle 20 is maintained in a stationary position.

It should be appreciated that while embodiments herein describe the sequence as the operator moving their foot from the brake pedal to the accelerator pedal in sequence, this is for exemplary purposes and the claimed invention should not be so limited. In other embodiments, the operator may depress the accelerator pedal while also keeping the brake pedal depressed. In this embodiment, the clamping force on the rotors 118 is maintained until at least two conditions are satisfied, such as a determination that the brake pedal is released and the engine torque being at a predetermined level.

When the torque delivered to the wheels 34, 60 is at a predetermined level, the EBCM 112 transmits a signal to the hydraulic system 59 to release the clamping force by the caliper 116 on the rotor 118. It should be appreciated that at this point the vehicle 20 starts to move and accelerate towards the desired speed. In the exemplary embodiment, the torque level (i.e. the release torque value) delivered to the wheels 34, 60 when the brakes 58, 61 are released is a maximum torque (or near maximum torque) that can be applied to the wheels 34, 60 without causing (or with a reduced the amount of) wheel slippage relative to the ground. It should be appreciated that this allows for a rapid acceleration of the vehicle 20 relative to a vehicle that is not held stationary. In one embodiment, the ECM 112 may further include sensors that determine the ground condition and adjust the release torque value based on the ground condition. For example, the input data 114 may include a first release torque value for wet conditions and a second release torque value for dry conditions, where the first release torque value is less than the second release torque value. It should be appreciated that while embodiments herein may describe two release torque values, this is for exemplary purposes and the claimed invention should not be so limited. In other embodiments the input data 114 may include multiple release torque values for a variety of surface/ground conditions.

In one embodiment, the brakes 58, 61 may be actuated by the ECM 112 to keep the wheels 34, 60 from slipping. This may provide advantages in increasing the amount of torque delivered to the wheel without wheel slippage. In this embodiment, the ECM 112 selectively applies clamping pressure on the rotors 118 to regulate the amount of torque applied to the wheels. The regulation of torque may be through a constant clamping force, a variable clamping force or by modulating the clamping force. It should be appreciated that ECM 112 determines the torque where the wheels are released by the brakes 58, 61 based on input data 114 that may related to the particular vehicle based on factors such as tire size, tire pressure, tread type and vehicle weight for example.

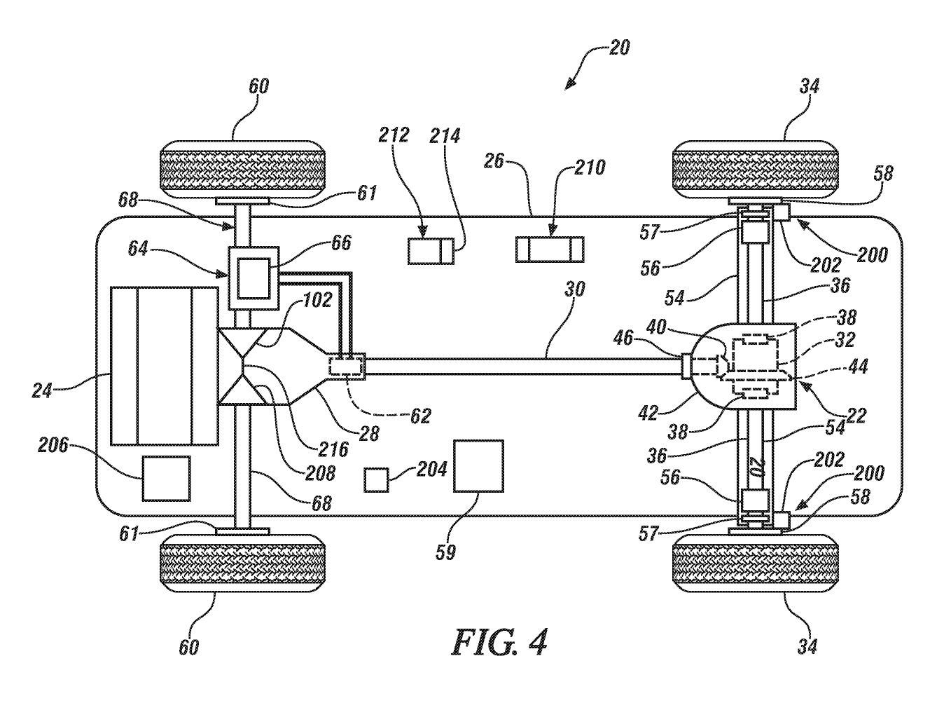

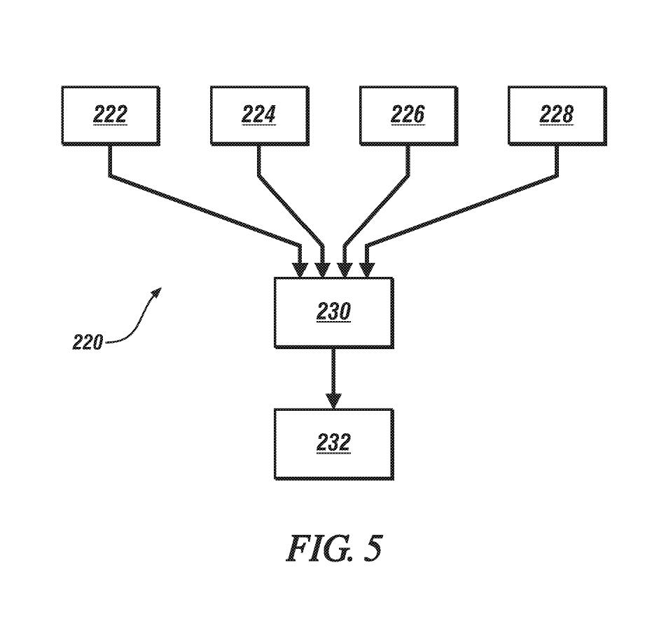

Referring now to FIG. 4 and FIG. 5, another embodiment of a system for limiting slippage of the wheels is provided. It should be appreciated that the vehicle 20 illustrated in FIG. 4 is similar to that of FIG. 1 and the description of similarly numbered parts will not be repeated. In this embodiment, the brake assembly 58 is also configured to function as a parking brake. In the exemplary embodiment, the brake assembly 58 includes an electronic parking brake system 200 having an electrical motor 202 that is coupled to a brake caliper. When a parking brake is activated by the operator (such as with a button or lever 204) the motors 202 actuate to squeeze the calipers onto the rotor. The brake assembly 58, electronic parking brake system 200, and the actuator 204, are operably connected to a brake controller 206. The brake assembly 58 is configured to selectively slow the rotation of the wheels 34 in response to an action by the operator, such as applying a brake pedal or activating a parking brake.

In the embodiment of FIG. 4, the transmission controller 208 is an electronic controller that uses sensors 210 from the vehicle 20 as well as data provided by a vehicle controller 212 to calculate how and when to change gears, via solenoids for example, in the vehicle for optimum performance, fuel economy and shift quality, in a manner known in the art. However, in an embodiment and as disclosed herein, the transmission controller 208 is also disposed and configured to apply an adjustment to limit an amount of clutch slip as the clutch temperature increases due to repeated launches of the vehicle 20, resulting in a change in clutch performance. The vehicle controller 212 has a processing circuit 214 responsive to executable instructions which when executed by the processing circuit 214 facilitates a change in a slip of the drive wheels 34, or drive wheels 34, 60, as a result of the change in clutch performance due to the applied adjustment. In an embodiment, drive wheel slip is controlled via the controller 212 by commanding the engine 24 to reduce its torque output, generally via quick torque reduction methods like fuel cutoff to one or more cylinders, and spark retard, as opposed to closing the throttle, since throttle control is relatively much slower. In an embodiment, the processing circuit 214 is further responsive to executable instructions which when executed by the processing circuit 214 facilitates a change in a slip of the drive wheels 34, or drive wheels 34, 60, based at least in part on a temperature of the transmission clutch 216, and more particularly facilitates a change in a slip of the drive wheels 34, or 34 and 60, based at least in part on a temperature of the transmission clutch 216. In an embodiment, the processing circuit 214 is further responsive to executable instructions which when executed by the processing circuit 214 also facilitates a change in the slip of the transmission clutch 216, via the transmission controller 208 or solenoids within the transmission controller (all components of the transmission controller including any solenoids are collectively herein referred to by reference numeral 208), based at least in part on the temperature of the transmission clutch 216. More specifically, the slip of the drive wheels 34, or 34 and 60, is facilitated upward in response to the temperature of the transmission clutch 216 having increased above a defined value, and the slip of the transmission clutch 216 is facilitated downward in response to the temperature of the transmission clutch 216 having increased above the defined value. It should be noted, however, that the propulsion torque is not being increased over what the driver is commanding via the accelerator pedal, as it is assumed that the accelerator pedal input is already at a high level, since the launch being controlled is a performance launch, and that wheel spin may be inevitable without transmission clutch slippage and/or engine torque reduction. By downwardly adjusting the slip of the transmission clutch 216 (i.e., increasing clutch pressure to further engage the clutch) when the temperature of the transmission clutch 216 exceeds a defined value, a further increase in the temperature of the transmission clutch 216 can be avoided. By simultaneously upwardly adjusting the slip of the drive wheels 34, or 34 and 60, (i.e., reducing traction of the wheels to the road) when the slip of the transmission clutch 216 is adjusted downwardly, a torque output of the engine 24 can be substantially maintained at a desired or optimal level while slip balancing is maintained.

In an embodiment, the processing circuit 214 is further responsive to executable instructions which when executed by the processing circuit 214 calculates a desired wheel slip, which is described generally according to the following equation:

Desired Wheel Slip=(Brake Controller Desired Engine Speed−Transmission Controller Desired Engine Speed)/(Transmission Ratio*Final Drive Ratio). Eq.-1:

In an embodiment, calculation of the transmission controller desired engine speed is determined by the vehicle controller 212 and is a function of an estimated clutch temperature, based on input from sensor 218 for example, so as to maintain driver intended torque while at the same time preventing clutch overheating. The phrase estimated clutch temperature is used herein as the temperature sensor 218 may be disposed in such a manner that it does not register the actual clutch temperature, but can be used to estimate the clutch temperature based on previously established experimental data, which can be retrieved via an electronically stored lookup table or calculated via a defined mathematical formula for example. The brake controller desired engine speed is determined by the vehicle controller 212 so as to maximize acceleration of the vehicle. The transmission ratio and the final drive ratio are defined parameters based on a specification of the vehicle 20 stored in a memory of the vehicle controller 212 (the memory and controller are collectively referred to herein by reference numeral 212). The calculated desired wheel slip value is used to facilitate a change in a slip of the drive wheel as a result of the change in clutch performance due to an applied adjustment to limit an amount of clutch slip.

FIG. 5 depicts a flowchart 220 of a method for determining the desired wheel slip that may be performed via the controller 212. At steps 222, 224, 226 and 228, the Brake Controller Desired Engine Speed, Transmission Controller Desired Engine Speed, Transmission Ratio, and Final Drive Ratio, are respectively obtained. At step 230, Eq.-1 is calculated. And at step 232, the Desired Wheel Slip is output for launch control.

Other sensors 210 used for launch control may include sensors used to sense any of the following: wheel speed; shaft input speed; engine speed; longitudinal acceleration; clutch temperatures (may also be estimated); transmission output torque (may also be estimated); engine torque (may also be estimated); vehicle speed (may also be estimated); brake pedal position; accelerator pedal position; steering wheel angle; lateral acceleration; and, yaw rate.

While an embodiment of the invention disclosed herein is directed to a dual clutch transmission (DCT), the invention can also be applied to an AMT (Automated Manual Transmission) as well as a manual transmission with an e-clutch.

While an embodiment of FIG. 5 refers to a controller 212 for performing certain functions like wheel slip control via engine torque reduction, it will be appreciated that any control module could be configured to do wheel slip control, such as the brake controller, for example, since the brake controller, as the supervisor of things like traction control, etc., can be used to control wheel slip, or the traction control torque interface could be used. Since the brake controller is also configured to read in wheel speeds, it would be a suitable control module to provide wheel slip control. As such, the invention disclosed herein contemplates one or more than one controller suitable for providing wheel slip control.

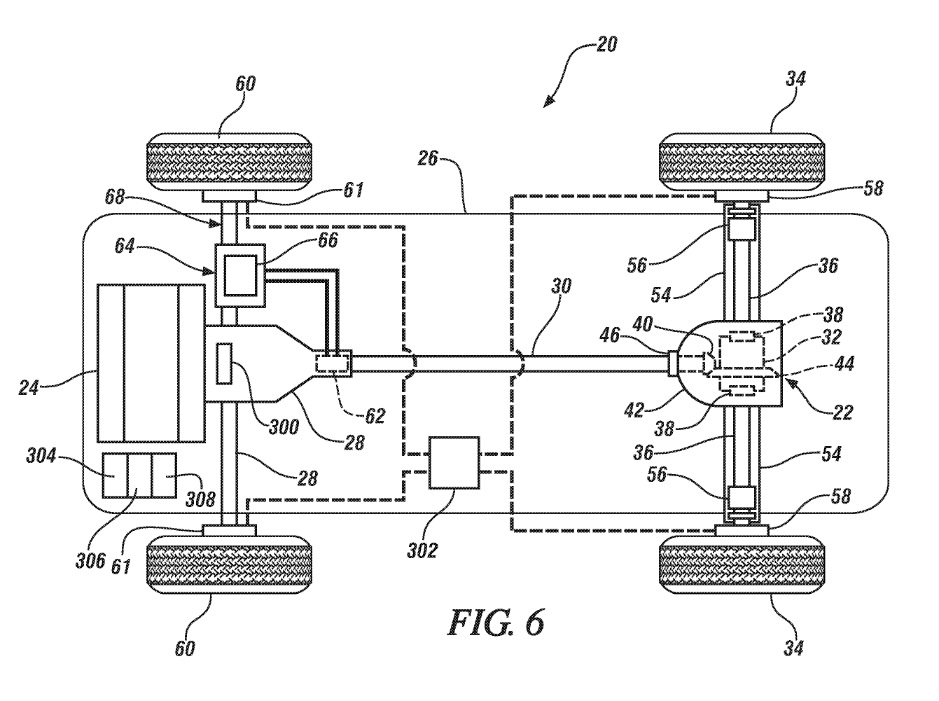

Referring now to FIGS. 6-9, another embodiment is shown for limiting slippage of the wheels. It should be appreciated that the vehicle 20 illustrated in FIG. 4 is similar to that of FIG. 1 and the description of similarly numbered parts will not be repeated. In this embodiment, the vehicle 20 that may include a frame or other chassis structure 26, an engine 24, a transmission clutch 300 and a transmission 28 that may be a dual-clutch transmission (DCT). The engine 24 and differential assembly 22 are engaged to the frame 26. The engine 24 is operatively coupled to the transmission 28 via the clutch 300 such that the clutch generally facilitates engagement and disengagement of the engine 24 from the driveshaft 30.

Similar to the vehicle 20 of FIG. 1, the rear wheels 34 are associated with brakes 58 and the front wheels 56 are associated with front brakes 61. In one example, the brakes 58, 61 are coupled to and actuated by a hydraulic system 302 that may be configured to selectively isolate the rear brakes 58 from the front brakes 61. The brakes 58, 61 and hydraulic system 302 are configured to selectively slow the rotation of the respective rear and front wheels 34, 60 in response to an action by the operator and/or command signals from a brake controller 304. The hydraulic system 302 may include a booster device that increases the amount of hydraulic force that is applied to the rear and front brakes 58, 61. The hydraulic system 302 may be mechanically driven by the engine 24 or electrically driven by a separate electrical motor (not shown). The brakes 58, 61 may be any known braking assembly used with vehicles, such as a caliper/rotor assembly.

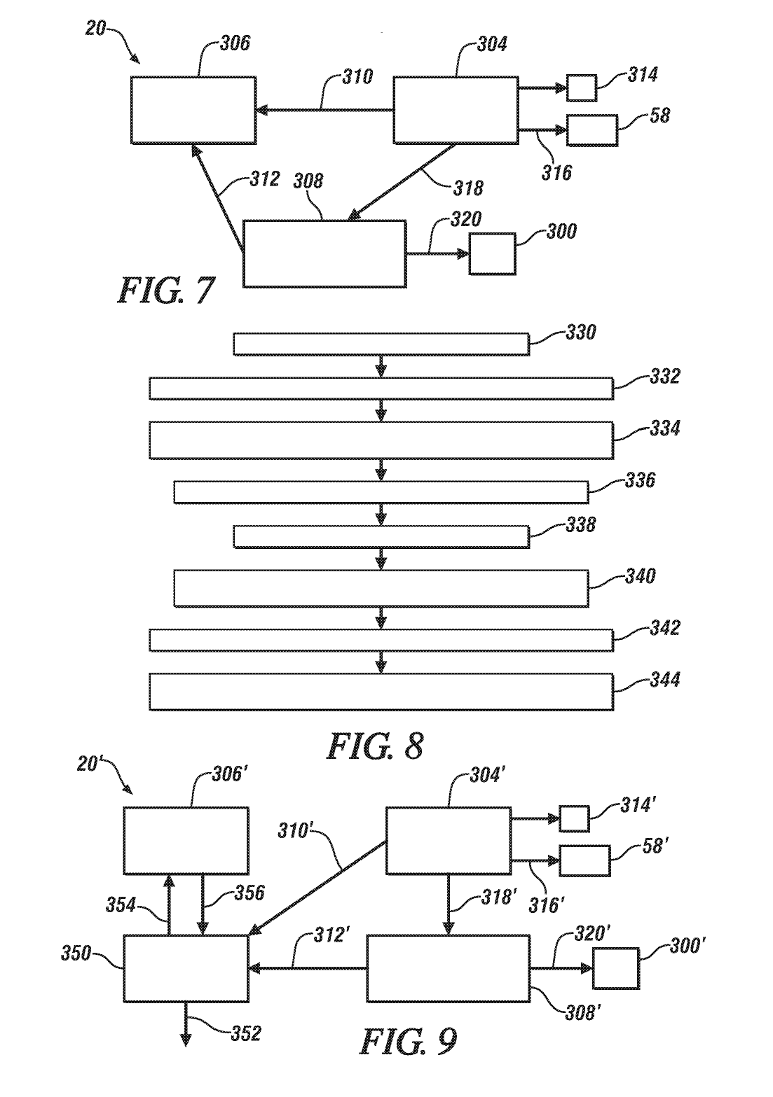

Referring now to FIG. 6 and FIG. 7, in addition to the brake controller 304, the vehicle 20 may further include an engine controller 306 and a transmission controller 308. The controllers 304, 306, 308 may be configured to receive various inputs from a variety of sensors, process the signals, and output executable instructions. Moreover, the controllers 304, 306, 308 may be configured to send information-based and command signals between controllers. The controllers 304, 306, 308 may be implemented using a computer-based processor (e.g., microprocessor) executing a computer program stored on a computer readable and writeable storage medium to perform the operations described herein. Alternatively, any one or more of the controllers 304, 306, 308 may be implemented in hardware (e.g., ASIC, FPGA) or in a combination of hardware/software. Although three controllers are illustrated as separate modules, it will be understood by those of ordinary skill in the art that any combination of controllers may be integrated together and defined as a ‘controller.’

The engine controller 306 is configured to, at least in-part, control engine speed as dictated by the torque demand of an operator (e.g., acceleration pedal position). The engine controller 306 may be further configured to receive instruction signals from one or both of the transmission controller 308 and the brake controller 304. For example, the engine controller 306 may receive at least one signal 310 from the brake controller 304 that is indicative of a torque reduction request when, for example, the clutch 300 is locked. More specifically, the brake controller 304, upon receiving sensory input indicative of excessive wheel slip, may send the signal 310 (e.g., torque reduction command signal) to the engine controller 306 commanding the engine 24 to reduce the engine output torque. This reduction in engine output torque may be accomplished, for example, by controlled fuel cut-off to selected engine cylinders, a spark challenge, or other methods that are sufficiently responsive. The engine controller 306 may also receive at least one signal 312 from the transmission controller 308 that may be indicative of an engine speed request, turbine angular velocity information, and/or the transmission clutch state.

The brake controller 304 is configured to operably communicate with the rear and front brakes 58, 61. In one non-limiting example, the brake controller 304 may be operably connected to the rear wheels 34 via the rear brakes 58, and may monitor and control wheel slip relative to a surface on which the vehicle 20 may travel via a speed sensor 314. The brake controller 304 may output a command signal 316 to the rear brake 58 to selectively slow the rotation of the rear wheels 34 in response to an action by the operator, such as applying a brake pedal, activating a parking brake, or in response to the brake controller 304. The brake controller 304 is configured to output the signal 310 as the torque reduction request that may be based on excessive wheel slip when the clutch 26 is locked. Alternatively, or in addition to, the brake controller 304 may output at least one signal 318 to the transmission controller 308 that may be indicative of a torque reduction request based on a target wheel slip value. This torque reduction request may be achieved, for example, by increasing clutch slip. The term “target” used with regard to wheel slip signifies a desired and controlled amount of wheel slip.

The brake controller 304 may also manage other features such as traction control. To control wheel slip, the existing traction control torque interface may be used. Because the brake controller 304 may be configured to read-in wheel speed via the speed sensor 314, this existing wheel speed signal may also be used to control, at least in-part, wheel slip as applicable for the present disclosure. It is further contemplated and understood that the engine controller 306 or the transmission controller 308 may be configured to control wheel slip.

The transmission controller 308 is operably connected to the transmission clutch 300 and may monitor and control transmission clutch slip. In one, non-limiting, example and during acceleration (i.e., before a defined vehicle speed is reached), the transmission controller 308 is configured to output a clutch command signal 320 to the clutch 300 that facilitates clutch slip to generally maximize engine speed or torque.

In another example, a processing circuit of at least one of the controllers 304, 306, 308 may be responsive to executable instructions that, when executed by the processing circuit, facilitates a change in a slip of the driven wheels 34 (or driven wheels 34, 60) based, at least in-part, on any one or combination of a temperature of the transmission clutch 300 and an optimal engine speed (i.e., engine torque output). More specifically, the slip of the driven wheels 34, 60 is facilitated upward in response to the temperature of the transmission clutch 300 having increased above a defined value, and the slip of the transmission clutch 300 is facilitated downward in response to the temperature of the transmission clutch 300 having increased above the defined value. By downwardly adjusting the slip of the transmission clutch 300 (i.e., increasing clutch pressure to further engage the clutch) when the temperature of the transmission clutch 300 exceeds a defined value, a further increase in the temperature of the transmission clutch 300 can be avoided. Moreover, by simultaneously and upwardly, adjusting the slip of the driven wheels 34, 60 (i.e., reducing traction of the wheels to the road) when the slip of the transmission clutch 300 is adjusted downwardly, a torque output of the engine 24 can be substantially maintained at a desired or optimal level.

In yet another example, the processing circuit of at least one of the controllers 304, 306, 308 may be responsive to executable instructions, which when executed by the processing circuit, facilitates a change in a slip of the driven wheels 34 (or driven wheels 34, 60) based, at least in-part, on any one or combination of clutch slip and an optimal engine speed (i.e., engine torque output). More specifically, the slip of the driven wheels 34 is facilitated upward in response to excessive clutch slip that may otherwise require a reduction in engine speed. As one example, by downwardly adjusting the slip of the transmission clutch 300, the transmission output torque can be substantially maximized. In the alternative (or a combination thereof), by upwardly adjusting wheel slip, engine speed can be maintained, or any reduction in engine speed can be minimized, thus optimizing engine torque output during acceleration.

It is further understood that optimizing or maximizing engine speed or torque, as described above, may not mean increasing engine speed above that commanded by the driver via the accelerator pedal. It is assumed that the accelerator pedal input is already at a high level, since the launch being controlled may be a performance launch, and that wheel spin may be inevitable without transmission clutch slippage and/or engine torque reduction.

Other sensors used for launch control may include sensors used to sense any of the following: wheel speed; shaft input speed; engine speed; longitudinal acceleration; clutch temperatures (may also be estimated by the controller); transmission output torque (may also be estimated); engine torque (may also be estimated); vehicle speed (i.e., may also be estimated); brake pedal position; accelerator pedal position; steering wheel angle; lateral acceleration; and, yaw rate.

Benefits of the present disclosure thus includes a vehicle 20 having improved launch performance by controlling the wheel spin to a higher level so the engine speed can remain at a higher, more optimal level. Control of the wheel spin is provided by a method of controlling the wheel slip during any particular launch based on the transmission clutch capability. The control can be facilitated in a continuous manner, or at discrete levels of slip as a function of discrete levels of clutch preload.

In order to maintain engine torque output, which is a function of engine speed among other things, at an optimal level for acceleration, an embodiment of the present disclosure balances clutch slip and wheel slip. As clutch temperature increases due to repeated launches, the transmission controller 74 may limit the amount of clutch slip. Without any other action, this will have the tendency to reduce engine speed. Using clutch information as an input, the target wheel slip value (delta velocity between the driven wheels and the vehicle speed) can be increased to compensate for the lower amount of clutch slip. In this way, the two slips can be balanced and engine speed controlled to the correct level.

Referring to FIG. 8, a method of achieving performance launch control is illustrated. In block 330 a desired engine output torque is produced. The desired engine output torque may be established by, for example, a driver depressing a gas pedal. In block 332, wheel slip of, for example, the wheel 34 may be monitored by the sensor 314, and relative to a surface upon which the vehicle 20 travels. In block 334, a computer-based controller (e.g., brake controller 304) compares the sensed wheel slip to a target wheel slip value. In block 336, based on the comparison between the sensed wheel slip and the target wheel slip value (i.e., target wheel slip value is reached), the computer-based controller (e.g., the transmission controller 308), may increase clutch slip of the clutch 300. In one example, by increasing clutch slip to decrease wheel slip any reduction in the desired engine output torque can be prevented or minimized More specifically, the engine controller 306 need not reduce engine speed and/or torque to prevent excessive wheel slip.

In block 338, a temperature of the clutch 300 may be monitored generally by, for example, the transmission controller 308. Monitoring of the clutch temperature may be achieved through a variety of means including use of a temperature sensor and/or an estimation executed by a controller. In block 340, the transmission controller 308 may compare the sensed clutch temperature to a predefined clutch temperature value established to, for example, preserve clutch durability. In block 342, the transmission controller 308 may decrease clutch slip when the predefined clutch temperature value is reached. In block 344, the wheel slip may be increased when the clutch slip is decreased to maximize engine output torque relative to the desired engine output torque. It is contemplated and understood that clutch temperature may take precedence over the target wheel slip value, thus wheel slip may exceed the target wheel slip value to reduce clutch temperature and thereby prevent excessive wear to the clutch. Alternatively or in addition to, the engine controller 306 may reduce the engine output torque to reduce clutch slip and/or reduce wheel slip. It is further contemplated that any one of the controllers 304, 306, 308 may apply an algorithm and/or may utilize multiple target wheel slip values that may be dependent upon other influencing factors such as, for example, clutch temperature.

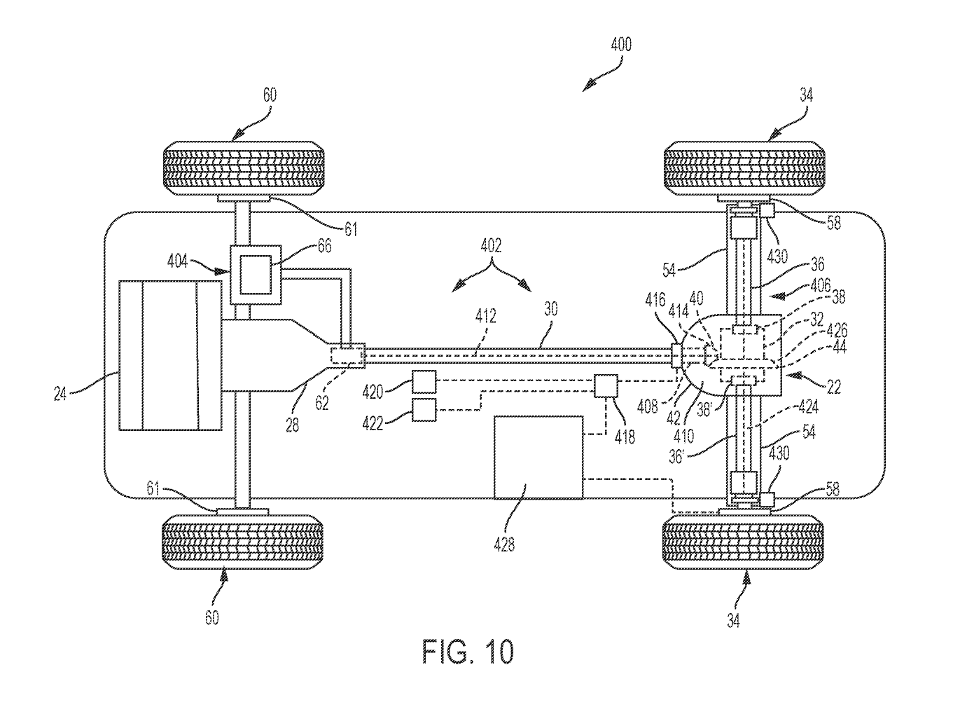

Referring to FIG. 9, a second embodiment of a vehicle is illustrated wherein like elements to the first embodiment have like identifying numerals except with the addition of a prime symbol as a suffix. A vehicle 20′ may include an engine controller 306′, a transmission controller 308′, a brake controller 304′ and a hybrid controller 350. The brake controller outputs a signal 318′ to the transmission controller 308′ and outputs a signal 310′ to the hybrid controller 350. The hybrid controller 350 may be configured to output an electric motor torque command signal 352 to an electric motor (not shown), and output an engine torque command signal 354 to the engine controller 306′. The engine controller 306′ may be configured to send an axle torque command signal 356 to the hybrid controller 100.

Referring now to FIG. 10, a schematic diagram is illustrated of a vehicle 400, illustrated according to another embodiment of the present disclosure. The first vehicle 400 has a driveline or drivetrain 402 that provides torque to one or more wheel assemblies to propel the vehicle 400. The drivetrain 402 may have a hybrid configuration that may employ multiple power sources or a non-hybrid configuration. The drivetrain 402 may include an engine 24, a transmission 28, a first axle assembly 404, and a second axle assembly 406.

Similar to engines described herein, the engine 400 generally represents a power source that includes an internal combustion engine such as a gasoline, diesel, natural gas powered engine, or fuel-cell. In at least one embodiment, the engine 400 is selectively coupled to an electric machine, such as a motor-generator. The engine 400 generates an engine power and a corresponding engine torque that is provided to the transmission 28.

The transmission 28 is of any suitable type, such as a multi-gear “step ratio” transmission, a continuously variable transmission “CVT,” or the like. The transmission 28 may provide torque to at least one of the first axle assembly 404 and the second axle assembly 406.

The first axle assembly 404 rotatably supports one or more first wheel assemblies 60. The first axle assembly 404 is configured as a drive axle that may provide torque to rotate associated first wheel assemblies 60 to propel the vehicle 400. An output of the transmission 28 is connected to an input of the first axle assembly 404. In at least one embodiment, an output of the transmission 28 is connected to a front differential 66 via a transfer case 62.

The second axle assembly 406 rotatably supports one or more second wheel assemblies 34. The second axle assembly 406 is disposed rearward of the first axle assembly 404.

The second axle assembly 406 is configured as a drive axle that may provide torque to propel the vehicle 400. The arrangement of having the first axle assembly 404 and the second axle assembly 406 configured as drive axles is referred to as a four-wheel or all-wheel drive configuration. In a four-wheel or all-wheel drive configuration, the transfer case 62 transmits a portion of the output torque of the transmission 28 to the first axle assembly 404 and a portion of the output torque of the transmission 28 to the second axle assembly 406. The transfer case 62 is coupled to an input of the second axle assembly 406 via a drive shaft 30. The drive shaft 30 interconnects an output of the transmission 28 with an input of a rear differential 22 that is operatively connected to the second axle assembly 406.

The rear differential 22 includes a differential housing 42, an input shaft 408, a ring gear or a drive gear 44, a differential unit 32, a first output shaft 36, and a second output shaft 36′. The differential housing 32 defines a cavity 410 that receives various components such as a portion of the input shaft 408, the drive gear 44, the differential unit 32, a portion of the first output shaft 36, and a portion of the second output shaft 36′. The front differential 66 may have a similar configuration as the rear differential 22.

The input shaft 408 is operatively connected to the transmission 28 and the transfer case 62 through the drive shaft 30 to receive torque from the engine 24. The input shaft 408 extends along and rotates about a first axis 412 and is operatively connected to the drive gear 44 via a pinion gear 40. The pinion gear 40 has a set of gear teeth 414 disposed about a periphery of the pinion gear 44. The gear teeth 414 may provide the pinion gear 44 with a bevel gear, hypoid gear configuration, or the like. The input shaft 408, via the pinion gear 44, provides torque to the drive gear 44.

In at least one embodiment, a drive motor 416 is connected to the input shaft 408. The drive motor 416 is an electric machine implemented by any one of a plurality of types of electric machines, such as a permanent magnet synchronous motor, or the like. The drive motor 416 is configured to selectively apply a torque to the input shaft 408 based on commands provided by a controller 418. The controller 418 is provided within input communication channels configured to receive signals indicative of an accelerator pedal position, a brake pedal position, a gear selection, or drive mode from an accelerator pedal 420, a brake pedal 422, a gear selector, drive mode selector, or a vehicle speed. The controller 418 is provided with output communication channels configured to provide signals indicative of a torque command to apply a torque to the input shaft 408 to impart motion the drive gear 44 to propel the vehicle or to apply torque to the input shaft 408 to adjust gear lash of the differential unit 32.

The controller 418 interprets a driver request from the accelerator pedal 420, to determine the driver's intention for demanded drivetrain 402 torque or power to propel the vehicle 400. The controller 418 may allocate torque split commands between the engine 20, the engine 20 having an electric machine, and/or the drive motor 416 to satisfy the driver request. In general, depressing the accelerator pedal 420 to change an accelerator pedal position generates an accelerator pedal position signal that is interpreted by the controller 418 as a demand for increased power/torque. In general, releasing the accelerator pedal 420 to change an accelerator pedal position generates an accelerator pedal position signal that is interpreted by the controller 418 as a demand for decreased power/torque to propel the vehicle 400.

The controller 418 interprets a driver request from the brake pedal 420, to determine a driver's intention for braking torque to reduce vehicle speed, release the vehicle 400 from a stop or standstill, or stop the vehicle 400. The controller 418 may allocate braking torque between a friction braking system and the drivetrain 402. In general, depressing and releasing the brake pedal 422 to change a brake pedal position, generates a brake pedal position signal that is interpreted by the controller 418 as a demand for brake torque, decreased power/torque from the drivetrain 402 to reduce vehicle speed or stop the first vehicle, or for a driver intention to launch or accelerate the vehicle 400 from a stop or standstill.

The drive gear 44 is configured to rotate about a second axis 424 that is disposed transverse to the first axis 412. The drive gear 44 has a set of teeth 426 that engage and mate with the corresponding set of gear teeth 414 of the pinion gear 40. The drive gear 44 and the pinion gear 40 cooperate with the differential unit 32 to provide torque to the first output shaft 36 and the second output shaft 36′.

An amount of play or lash (gear lash) may be present in geared components of the drivetrain 402. For example, a small amount of play or lash (gear lash) is provided between the gear teeth 414 of the pinion gear 40 and the teeth 426 of the drive gear 44. The amount of play or lash is adjusted to be within a predetermined manufacturing tolerance during assembly of the front differential 66 or the rear differential 22. Shims or adjusting rings may be provided to adjust the amount of play or lash by varying a bearing preload. Lash may be present even after the application of shims or adjustment of the adjusting rings due to manufacturing tolerances/variances, the deflection of the gear teeth 414 of the pinion gear 40 or the teeth 426 of the drive gear 44 during operation, thermal effects, or the presence of lubrication. During a vehicle launch, the gear lash of the rear differential 22 is taken up before forward torque is applied. Should the gear lash or compliance not be taken up there is a delay in the application of torque applied to at least one of the first axle assembly 404 and the second axle assembly 406 to propel the vehicle 400.

The gear lash that may be present between the gear teeth 414 of the pinion gear 40 of the input shaft 408 and the teeth 426 of the drive gear 44 may be taken up by applying a torque to the input shaft 408. The controller 418 may command the engine 20 and/or the drive motor 416 to apply the torque to the input shaft 408, in response to a brake pedal position becoming less than a threshold brake pedal position and a vehicle speed indicative of the vehicle 400 at a stop or standstill. The torque applied to the input shaft 408 slightly rotates or tensions the pinion gear 40 so that the gear teeth 414 of the pinion gear 40 more fully mesh with the teeth 426 of the drive gear 44 without imparting rotation or motion to the drive gear 32.

The controller 418 may command that the drive motor 416 apply the torque to the input shaft 408 in response to an anticipated vehicle launch event. The anticipated vehicle launch event may be anticipated based on a driver releasing the brake pedal 422 such that a brake pedal position becomes less than a brake pedal threshold position, while the vehicle 400 is at a stop or standstill. The torque applied to the input shaft 408 adjusts the gear lash without imparting motion to the drive gear 44. The controller 418 is further programmed to, in response to a vehicle launch event; provide a torque command to the drive motor 416 to apply a torque to the input shaft 408 to propel the vehicle 400. The vehicle launch event may also be based on a change in accelerator pedal position.

The differential unit 32 is disposed in the cavity 410 of the differential housing 42 and is rotatably supported by a pair of differential bearings. The differential unit 32 may support the drive gear 44 and is at least partially encompassed by the drive gear 44. The differential unit 32 is configured to control rotation of the first output shaft 36 and the second output shaft 36′. For example, the differential unit 32 may permit the first output shaft 36 and the second output shaft 36′ to rotate at different speeds or inhibit the first output shaft 36 and the second output shaft 36′ from rotating at different speeds. The differential unit 32 includes a first output gear 38 and a second output gear 38′.

The first output gear 38 is disposed proximate an end of the first output shaft 408. The first output gear 38 extends about the second axis 424 and may be connected thereto through a spline that receives and engages a corresponding spline on the first output shaft 36 to thereby inhibit rotation of the first output gear 38 with respect to the first output shaft 36. The first output gear 38 includes a set of teeth that are arranged on a side or face of the first output gear 38 that face towards the differential unit 32.

The second output gear 38′ is spaced apart from and disposed opposite the first output gear 38 and has substantially the same configuration as the first output gear 38. The second output gear 38′ is disposed proximate the second output shaft 36′ and extends about the second axis 424. The second output gear 38′ has a spline that receives and engages a corresponding spline on the second output shaft 36′ to inhibit rotation of the second output gear 38′ with respect to the second output shaft 36′. The second output gear 38′ also includes a set of teeth that are arranged on a side or face of the second output gear 38′ that face towards the differential unit 32.

The first output shaft 36 extends towards a first wheel of the second wheel assembly 34 and is at least partially received within a first axle tube 54. The first axle tube 54 has a hollow interior that extends along its length. A brake assembly 58 is operatively coupled to at least one of the first wheel of the second wheel assembly 34 and the first output shaft 36. The brake assembly 58 selectively slows the rotation of the first wheel of the second wheel assembly 40 in response to application of the brake pedal 422 or activation of a parking brake. The brake assembly 58 is in communication with a brake controller 428. The brake controller 428 is configured to operate the brake assembly 58 as a standard vehicle brake and as a parking brake. The brake controller 428 may be directly in communication with the brake pedal 422. In at least one embodiment, the brake controller 428 may be in communication with the brake pedal 422 through the controller 418. In at least one embodiment, the controller 418 and the brake controller 428 may be integrated together as part of an overall vehicle controller or control system.

The brake controller 428 is in communication with an electric motor 430 that is disposed proximate the brake assembly 58. The electric motor 430 is coupled to a brake caliper or other brake component. The electric motor 430 may activate the brake assembly 58 when the brake pedal 422 is activated to restrict or inhibit rotation of an associated second wheel assembly 34.

The second output shaft 36′ extends towards a second wheel of the second wheel assembly 34. The second output shaft 36′ is at least partially received within a second axle tube 54 having a hollow interior that extends along its length. The brake assembly 58 is operatively coupled to at least one of the second wheel of the second wheel assembly 34 and the second output shaft 34′ to selectively slow the rotation of the second wheel of the second wheel assembly 34 in response to application of the brake pedal 422 and/or activation of a parking brake.

The first wheel assemblies 60 are also provided with brake assemblies 61. The brake assemblies 61 selectively slow the rotation of each wheel of the first wheel assemblies 60 in response to application of the vehicle brake pedal or activation of a parking brake.

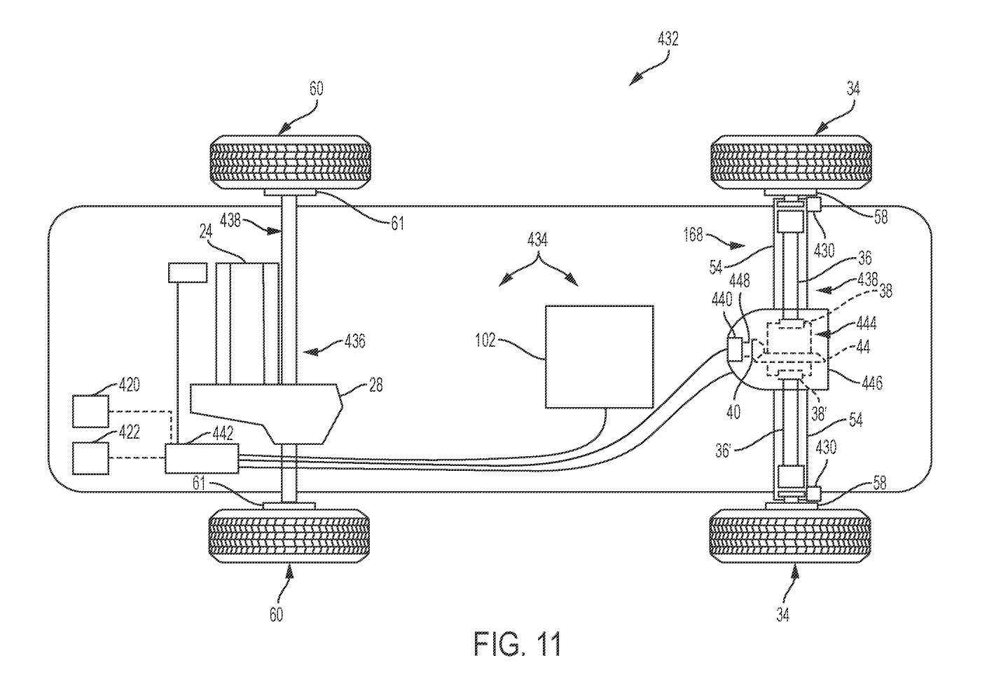

Referring to FIG. 11, another vehicle 432 is shown. The vehicle 432 has a similar configuration as the vehicle 400 of FIG. 10 and similar to the vehicle 20 of FIG. 2, the vehicle 432 has a split drivetrain 434. The split drivetrain 434 has a front drive system 436 and a rear drive system 438. The front drive system 436 and the rear drive system 438 may each propel the vehicle 432 in tandem, in combination, or separately.

The front drive system 436 includes an engine 24, a transmission 28, and at least one front drive axle 438. The engine 24 and the transmission 28 may be configured as previously discussed with respect to the vehicles of other embodiments described herein. The combination of the transmission 28 and the front drive axle 438 is commonly referred to as a trans axle. The front drive axle 438 rotatably supports one or more first wheel assemblies 60 and provides torque to rotate an associated first wheel assembly 60 to propel the vehicle 432. An output of the transmission 28 is connected to an input of the front drive axle 438.

The rear drive system 438 includes a rear drive motor 440, a battery system 102, a controller 442, a rear drive differential 166, and at least one rear drive axle 36, 36′. The rear drive motor 440 and the rear drive differential 444 may be disposed within a rear drive module housing 446. The rear drive module housing 446 may be an interchangeable unit that includes components that are configured to provide motive power such as an electric motor, a gear assembly, an internal combustion engine, or other components capable of aiding in propelling the vehicle 420. The rear drive motor 440 is a drive motor or an electric machine implemented by any one of a plurality of types of electric machines, such as a permanent magnet synchronous motor, or the like. Power electronics may condition power provided by the battery system 102 to the requirements of the rear drive motor 440. It should be understood that the front drive system 436 may be an electrically driven system and the rear drive system 438 may be internal combustion driven. Other combinations are also contemplated such as having an electrically driven front drive system 436 and an electrically driven rear drive system 438 such that all wheels are electrically driven by.

The controller 442 is in communication with the rear drive motor 440, the battery system 102, and the rear drive differential 444. The controller 442 is provided with input communication channels configured to receive signals indicative of a state of charge of the battery system 102, an accelerator pedal position, a brake pedal position, a gear selection, a drive mode, or a vehicle speed. The controller 442 is provided with output communication channels configured to provide signals indicative of a vehicle launch event command to the battery system 102 to supply power to the rear drive motor 440 to provide torque to the rear drive differential 444 to propel the vehicle or to provide torque to adjust gear lash of the rear drive differential 444. The controller 442 is configured to command the rear drive motor 440 to apply a torque to the rear drive differential 444 to propel the vehicle 432. The rear drive differential 444 may have a similar configuration as the rear differential 22 of FIG. 10.

An input shaft 448 is operatively connected to the rear drive motor 440. The input shaft 448 receives torque from the rear drive motor 440 and applies the torque to the rear drive differential 444, such that the rear drive axle 36, 36′ provides torque to rotate associated second wheel assemblies 34 to propel the vehicle 432.

The rear drive motor 440 is configured to selectively apply a torque to the input shaft 448 based on commands provided by the controller 442. The controller 442 interprets the signals to determine the driver's intention for demanded drivetrain 434 torque or power to propel the vehicle 432. The controller 442 may allocate torque split commands between the front drive system 436 and the rear drive system 438 to satisfy the driver request. In general, depressing and releasing the accelerator pedal 420 to change an accelerator pedal position, generates an accelerator pedal position signal that is interpreted by the controller 442 as a demand for increased power/torque or decreased power/torque, to propel the vehicle 432.

The controller 432 interprets a signal from the brake pedal 422, to determine a driver's intention for braking torque to reduce vehicle speed, to release the vehicle 432 from a stop or standstill, or to stop the vehicle 432. The controller 442 may allocate braking torque between the braking assembly 61 and the drivetrain 434. In general, depressing the brake pedal 420 to change a brake pedal position generates a brake pedal position signal that is interpreted by the controller 442 as a demand for brake torque, activation of the brake assemblies 61, or a decreased power/torque from the drivetrain 434 to reduce vehicle speed or stop the vehicle 432. In general, releasing the brake pedal 422 to change a brake pedal position generates a brake pedal position signal that is interpreted by the controller 442 as a driver intention to launch or accelerate the vehicle 432 from a stop or standstill.

An amount of play or gear lash may also be present in the geared components of the split drivetrain 432. For example, a small amount of play or gear lash is provided between a pinion gear 40 of the input shaft 448 and a drive gear 44 disposed within the rear drive differential 444. The amount of play or gear lash is adjusted to be within a predetermined manufacturing tolerance during assembly of the rear drive differential 444. Shims or adjusting rings are provided to adjust the amount of play or gear lash by varying a bearing preload. However, gear lash may be present even after the application of shims or adjustment of the adjusting rings due to manufacturing tolerances/variances, the deflection of the teeth of the pinion gear or the ring gear during operation, thermal effects, and the presence of lubrication. During a vehicle launch, the gear lash in the split drivetrain 434 is taken up before forward torque is applied in response to depression of an accelerator pedal. Should the gear lash not be taken up there may be a delay in the application of torque by the rear drive differential 444 to the rear drive axle 36, 36′ to propel the vehicle 432.

The controller 442 is provided with a gear lash adjustment strategy to avoid delays in the application of forward torque to at least one of the front drive axle 438 and the rear drive axle 438 during a vehicle launch event. The gear lash adjustment strategy is embodied as control logic within the controller 442. The gear lash adjustment strategy may be enabled while the drivetrain 434 is operated in a performance mode, sport mode, aggressive mode, track mode, or other operating mode where a driver of at least one of the vehicle 400 and the vehicle 432 expects enhanced performance. The gear lash adjustment strategy may result in the controller 442 outputting a rear drive motor command that requests the battery system 102 provide power to the rear drive motor 440 or a command directly to the rear drive motor 440 to apply a first torque to the input shaft 448 in response to an anticipated vehicle launch event to adjust a gear lash of the rear drive differential 444.

The rear drive motor 440 may apply a torque to the input shaft 448 prior to or in anticipation of the vehicle launch event. The anticipated vehicle launch event may be a release of the brake pedal 422 (i.e. the brake pedal position becoming less than a threshold brake pedal position) while the vehicle is at a stop or a standstill, an anticipated accelerator pedal 420 tip-in (i.e. depression of the accelerator pedal 420) or changes in brake pedal position while the vehicle 432 is stopping, at rest and operational, or immediately after a stop.

In other embodiments, the vehicle launch event is anticipated as a vehicle speed decreases in response to application of the brake pedal 422, a brake pedal position remaining constant for a predetermined period of time while the vehicle 432 is at rest and operational, a brake pedal position decreases (brake pedal position decreasing to a brake pedal position less than a threshold brake pedal position) while the vehicle is at rest and operational as indicated by a vehicle speed indicative of the vehicle at a stop, a standstill, or approaching a stop or standstill, a brake pedal tip-out greater than a threshold tip-out (i.e. release of the brake pedal), a brake pedal release rate greater than a threshold brake pedal release rate, an anticipated accelerator pedal tip-in greater than a threshold tip-in, an anticipated change in accelerator pedal position greater than a threshold accelerator pedal position, or an accelerator pedal depression greater than a threshold accelerator pedal depression rate. The torque applied to the input shaft 172 slightly rotates or tensions the pinion gear 40 so that the gear teeth of the pinion gear 40 more fully mesh with the gear teeth of the drive gear 44 without imparting rotation or motion to the drive gear 44.

If at least one of, or a combination of, the above described vehicle launch anticipation events occurs, the controller 442 generates a rear drive motor command. The rear drive motor command includes a command to provide battery system power to the rear drive motor 440 to apply a first torque to the input shaft 448. The application of the first torque to the input shaft 448 by the rear drive motor 440 rotates the pinion gear 40 relative to the drive gear 44 without imparting motion to the drive gear 44. The pinion gear 40 is rotated relative to the drive gear 44 to adjust or take up gear lash between the pinion gear 40 of the input shaft 448 and the drive gear 44 of the rear drive differential 444 prior to a vehicle launch event.

The adjustment of the gear lash between the pinion gear 40 of the input shaft 448 and the drive gear 44 of the rear drive differential 444 may result in the rotation of the pinion gear 40 relative to the drive gear 44 causing the pinion gear teeth to move relative to the drive gear teeth adjusting an amount of clearance between the meshed or mated gear teeth prior to the vehicle launch event. Subsequent to the taking up of gear lash between the pinion gear 40 of the input shaft 448 and the drive gear 44 of the rear drive differential 444, the controller 442 generates a second rear drive motor command. The second rear drive motor command includes a command to provide battery system power to the rear drive motor 440 to apply a second torque that is greater than the first torque to the input shaft 448 to propel the vehicle based on an accelerator pedal position.

It should be appreciated that while the embodiments herein describe individual or discrete systems and methods for controlling wheel slip and improving acceleration of the vehicle, this is for exemplary purposes and the claimed invention should not be so limited. In other embodiments, the systems and methods described with reference to FIGS. 1-11 may be combined together to reduce wheel slip and improve acceleration of the vehicle.

Embodiments of the present invention provide advantages in reducing or shortening the launch time of a vehicle to improve acceleration performance. Further embodiments of the invention provide advantages in improving launch performance of a vehicle that is launched repeatedly. Further advantages are provided in reducing a potential clutch over-heat condition that may make it impossible or destructive to apply an optimal amount of pre-load clutch torque during a launch. Additional advantages are provided by allowing continued use of launch control when transmission clutches have limited performance due to thermal concerns, such as when launches are performed very close together.

An embodiment of the invention may be embodied in the form of computer-implemented processes and apparatuses for practicing those processes. An embodiment of the invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), keep-alive memory (KAM), erasable programmable read only memory (EPROM), electrically erasable programmable read only memory (EEPROM), or flash memory, for example, wherein, when the computer program code is loaded into and executed by a computer or a processing circuit, the computer or processing circuit becomes an apparatus for practicing the invention. For example. KAM is a persistent or non-volatile memory that may be used to store various operating variables while the CPU is powered down. An embodiment of the invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits.

Examples of the controllers described herein include, but are not limited to, an arithmetic logic unit, which performs arithmetic and logical operations; a control unit, which extracts, decodes, and executes instructions from a memory; and an array unit, which utilizes multiple parallel computing elements. Other examples of the controllers include a drivetrain control module, an electronic control unit/controller, and an application specific integrated circuit. The controllers described herein may include any processing hardware, software, or combination of hardware and software that carries out computer readable program instructions by performing arithmetical, logical, and/or input/output operations.

In an embodiment, a technical effect of the executable instructions is to facilitate a change in a slip of the drive wheel as a result of a change in clutch performance due to an applied adjustment to limit an amount of clutch slip. In another embodiment, a technical effect of the executable instructions is to facilitate a change in a slip of the drive wheel to maximize driveline torque. In another embodiment, a technical effect of the executable instructions includes performing gear lash adjustment strategy to reduce or eliminate gear lash prior to transfer of torque to the wheels.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. A vehicle comprising:
a braking system having a rotor and a caliper;
a propulsion system;
at least one sensor coupled to the vehicle to determine an acceleration characteristic; and
a controller electrically coupled to the propulsion system, the braking system and the at least one sensor, the controller being responsive to executable computer instructions when executed on a processor for transmitting a brake-holding signal to the braking system in response to receiving an acceleration signal from the at least one sensor and transmitting a release signal to the braking system to release a clamping force by the caliper in response to the propulsion system outputting a predetermined torque.

2. The vehicle of claim 1, wherein the controller is further configured to determine a release torque value and transmit the release signal when the predetermined torque is equal to or greater than the release torque value.

3. The vehicle of claim 2, wherein the release torque value is based at least in part on vehicle factors.

4. The vehicle of claim 3, wherein the vehicle factors include tire size, tire pressure, tread type or vehicle weight and the release torque value is further based on a ground condition.

5. The vehicle of claim 2, further comprising:
a brake pedal operably coupled to the braking system;
a brake sensor configured to measure a brake parameter associated with the brake pedal, the brake sensor being configured to emit a brake signal in response to an operator releasing the brake pedal;
an accelerator pedal operably coupled to the propulsion system;
an accelerator sensor configured to measure an accelerator parameter associated with the accelerator pedal, the accelerator sensor being configured to emit an accelerator signal in response to the operator depressing the accelerator pedal;
wherein the controller is further responsive to increasing the clamping force in response to receiving the accelerator signal and transmit the brake-holding signal in response to receiving the brake signal.

6. A vehicle comprising:
at least one transmission clutch;
a drive wheel operably connected to the at least one transmission clutch;
a transmission controller operably disposed and configured to apply an adjustment to limit an amount of clutch slip as the clutch temperature increases due to repeated launches of the vehicle, resulting in a change in clutch performance; and
a controller having a processing circuit responsive to executable instructions which when executed by the processing circuit facilitates a change in a slip of the drive wheel as a result of the change in clutch performance due to the applied adjustment.

7. The vehicle of claim 6, further comprising:
at least one sensor operably connected to sense or estimate a temperature of the at least one transmission clutch; and
wherein the processing circuit is further responsive to executable instructions which when executed by the processing circuit facilitates the change in the slip of the drive wheel based at least in part on a temperature of the at least one transmission clutch.

8. The vehicle of claim 7, wherein the slip of the drive wheel is facilitated upward in response to the temperature of the at least one transmission clutch having increased above a defined value.

9. The vehicle of claim 8, further comprising:
an engine operably connected to the at least one transmission clutch;
wherein in response to the slip of the at least one transmission clutch being facilitated downward, and the slip of the drive wheel being facilitated upward, a torque output of the engine is substantially maintained during slip balancing;
wherein the processing circuit is further responsive to executable instructions which when executed by the processing circuit facilitates a change in the slip of the at least one transmission clutch based at least in part on the temperature of the at least one transmission clutch; and
wherein the slip of the at least one transmission clutch is facilitated downward in response to the temperature of the at least one transmission clutch having increased above a defined value.

10. The vehicle of claim 6, wherein the at least one transmission clutch is a dual-clutch.

11. A vehicle comprising:
a transmission clutch;
a driven wheel operably connected to the transmission clutch;
a sensor configured to monitor wheel slip of the driven wheel; and
a computer-based controller configured to receive a monitored wheel slip signal from the sensor indicative of the monitored wheel slip and compare the monitored wheel slip to a target wheel slip value, and wherein the computer-based controller is configured to control clutch slip of the transmission clutch based on the monitored wheel slip to substantially maintain engine output torque during acceleration.

12. The vehicle set forth in claim 11, further comprising:
a brake operably connected to the driven wheel and configured to control wheel slip based at least in-part by an output command from the brake controller;
wherein the transmission controller is configured to control clutch slip based at least in-part on the torque reduction request signal; and
wherein the computer-based controller includes a brake controller configured to monitor the brake slip via the sensor and a transmission controller configured to monitor clutch slip of the transmission clutch, and wherein the brake controller is configured to receive the monitored wheel slip signal and compare to the target wheel slip value, and output a torque reduction request signal to the transmission controller based on the wheel slip comparison.

13. The vehicle set forth in claim 11, wherein the sensor is configured to detect speed of the driven wheel indicative of wheel slip.

14. The vehicle set forth in claim 11 further comprising a brake operably connected to the driven wheel and configured to control wheel slip based at least in-part by an output command signal from the computer-based controller.

15. The vehicle set forth in claim 12 further comprising:
an engine configured to produce the engine output torque, and operably connected to the transmission clutch, and wherein the computer-based controller includes an engine controller configured to control engine speed based on an operator torque command and an input signal received from the transmission controller indicative of at least one of an engine speed request, a turbine angular velocity and a transmission clutch state, and wherein the engine speed is maximized based at least in part on an increase in wheel slip; and
wherein the input signal received from the transmission controller is further indicative of at least one of an engine speed request, a turbine angular velocity and a transmission clutch state.

16. A vehicle comprising:
a differential unit that controls rotation of a first output shaft with respect to a second output shaft;
a drive motor that is operatively connected to an input shaft that is operatively connected to the differential unit; and
a controller programmed to, in response to an anticipated vehicle launch event, command the drive motor to apply a first torque to the input shaft to adjust a gear lash of the differential unit.

17. The vehicle of claim 16, wherein the gear lash of the differential unit is defined between a pinion gear of the input shaft and a drive gear of the differential unit.

18. The vehicle of claim 17, wherein the gear lash is adjusted without imparting motion to the drive gear.

19. The vehicle of claim 18, wherein the anticipated vehicle launch event is based on a brake pedal position becoming less than a brake pedal threshold while the vehicle is stopped.

20. The vehicle of claim 19, wherein:
the controller is further programmed to command the drive motor to apply a second torque that is greater than the first torque to the input shaft to impart motion to the drive gear, in response to a change in accelerator pedal position; and
the gear lash is adjusted prior to a vehicle launch event.
